(19) United States
(12) Patent Application Publication
(10) Pub. No.: US 2026/0367340 A1
(43) Pub. Date: Nov. 19, 2026

(54) OPTICAL ASSEMBLIES FOR LIGHT COUPLING OF PHOTONIC CHIPS

(71) Applicant: GlobalFoundries U.S. Inc., Malta, NY (US)

(72) Inventor: A K M ZAHIDUR CHOWDHURY, New Windsor, NY (US)

(21) Appl. No.: 19/208,636

(22) Filed: May 15, 2025

(51) Int. Cl. G02B 6/42

(52) U.S. Cl. CPC G02B 6/4239

(57) ABSTRACT

The embodiments herein relate to optical assemblies for light coupling of photonic chips and methods of forming the same. The optical assembly may include a photonic chip, an optical fiber ribbon, and a fixture over the optical fiber ribbon. The optical fiber ribbon may include a plurality of optical fibers each sheathed with an outer protective coating and the optical fibers are exposed at an end portion of the optical fiber ribbon. The exposed optical fibers are coupled to the photonic chip. The fixture includes a first end over the exposed optical fibers and a second end over the sheathed portion of the optical fiber ribbon.

### TECHNICAL FIELD

The present disclosure relates generally to photonic chips, and more particularly to optical assemblies for light coupling of photonic chips and methods of forming the same.

### BACKGROUND

Photonic chips are rapidly becoming the cornerstone of modern optical communication systems, enabling compact, high-speed, and energy-efficient data transmission. One of the critical aspects of these optical communication systems is the effective and reliable coupling of optical signals to photonic chips. Optical fiber ribbons, which house multiple optical fibers in a parallel arrangement, offer high data throughput and scalability compared to single optical fibers.

However, achieving precise alignment and stable attachment of the optical fiber ribbons to the photonic chips presents significant challenges. For example, the process of coupling optical fiber ribbons to photonic chips is highly time-consuming, often requiring meticulous active alignment to ensure proper positioning. This challenge is further magnified in applications where the assembly is intended to be temporary, such as for testing or probing purposes, where quick and repeatable alignment is critical. Therefore, optical assemblies enabling precise alignment and stable attachment of optical fiber ribbons to photonic chips for light coupling are desired.

### SUMMARY

To achieve the foregoing and other aspects of the present disclosure, optical assemblies for light coupling of photonic chips and methods of forming the same are presented.

According to an aspect of the present disclosure, an optical assembly is provided. The optical assembly may include a photonic chip, an optical fiber ribbon, and a fixture over the optical fiber ribbon. The optical fiber ribbon may include a plurality of optical fibers each sheathed with an outer protective coating and the optical fibers are exposed at an end portion of the optical fiber ribbon. The exposed optical fibers are coupled to the photonic chip. The fixture includes a first end over the exposed optical fibers and a second end over the sheathed portion of the optical fiber ribbon.

According to another aspect of the present disclosure, a method of forming an optical assembly is provided. The method includes coupling a fixture over an optical fiber ribbon and coupling the optical fiber ribbon with the fixture to a photonic chip. The optical fiber ribbon includes an end portion exposing a portion of optical fibers and the exposed optical fibers are vertically between the photonic chip and the fixture.

### BRIEF DESCRIPTION OF THE DRAWINGS

The embodiments of the present disclosure will be better understood from a reading of the following detailed description, taken in conjunction with the accompanying drawings.

FIGS. 1A to 1C are views of an optical assembly before a fiber attachment process, according to an embodiment of the disclosure. FIG. 1A is a perspective view, FIG. 1B is a top-down view, and FIG. 1C is a cross-sectional view of the optical assembly, taken generally along line 1C-1C in FIG. 1B.

FIG. 2 is a cross-sectional view of an optical assembly after a fiber attachment process, according to another embodiment of the disclosure.

FIG. 3 is a cross-sectional view of an optical assembly after a fiber attachment process, according to yet another embodiment of the disclosure.

FIG. 4 is a top-down view of an optical assembly after a fiber attachment process, according to a further embodiment of the disclosure.

For simplicity and clarity of illustration, the drawings illustrate the general manner of construction, and certain descriptions and details of features and techniques may be omitted to avoid unnecessarily obscuring the discussion of the described embodiments of the device.

Additionally, elements in the drawings are not necessarily drawn to scale. For example, the dimensions of some of the elements in the drawings may be exaggerated relative to other elements to help improve understanding of embodiments of the device. The same reference numerals in different drawings denote the same elements, while similar reference numerals may, but do not necessarily, denote similar elements.

### DETAILED DESCRIPTION

The present disclosure relates to photonic devices, and more particularly to optical assemblies for light coupling of photonic chips and methods of forming the same. Various embodiments of the present disclosure are now described in detail with accompanying drawings. It is noted that like and corresponding elements are referred to by the use of the same reference numerals. The embodiments disclosed herein are exemplary, and not intended to be exhaustive or limiting to the disclosure.

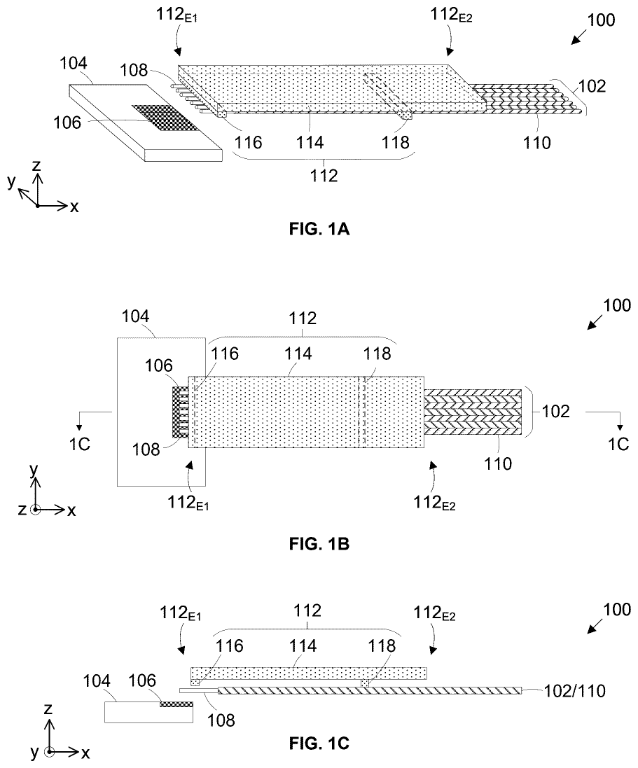

FIGS. 1A to 1C are various views of an optical assembly 100, according to an embodiment of the disclosure. FIG. 1A is a perspective view, FIG. 1B is a top-down view, and FIG. 1C is a cross-sectional view, taken generally along line 1C-1C in FIG. 1B, of the optical assembly 100. The optical assembly 100 may include an optical fiber ribbon 102 coupled to a photonic chip 104. In particular, FIGS. 1A to 1C illustrate the optical assembly 100 before the optical fiber ribbon 102 is attached to the photonic chip 104.

The photonic chip 104, also commonly referred to as a photonic integrated circuit (PIC) chip, may be manufactured using complementary metal-oxide semiconductor (CMOS) technology. The photonic chip 104 may include photonic components, such as modulators, polarizers, or optical detectors, arranged in a functional photonic circuit configured to manipulate light received from a light source, such as the optical fiber ribbon 102. The photonic chip 104 may further include a fiber alignment structure 106 having a plurality of V-grooves. The fiber alignment structure 106 may provide a physical guide for the precise alignment of the optical fiber ribbon 102, and may be coupled to a waveguide (not shown) in the photonic chip 104. The fiber alignment structure 106 may be formed on the photonic chip 104 using a patterning technique, including lithography and etching processes.

The optical fiber ribbon 102 may include a plurality of optical fibers 108 arranged in a parallel configuration. Each optical fiber 108 may be made of, for example, glass or plastic. The optical fiber 108 may be sheathed by an outer protective coating 110 made of, for example, rubber, flexible plastic, or fabric. An end portion of the optical fiber ribbon 102 may have the outer protective coating 110 removed to expose a portion of the optical fibers 108 for coupling the optical fiber ribbon 102 to the photonic chip 104 through the fiber alignment structure 106. The exposed optical fibers 108 may be spaced apart from an immediately adjacent exposed optical fiber 108 and may exhibit a slight degree of mechanical flexibility, i.e., the exposed optical fibers 108 may flex up, down, left, or right to a slight degree without permanent deformation. This mechanical flexibility may enable the exposed optical fibers 108 to self-align to the V-grooves of the fiber alignment structure 106, adjusting the position and orientation during the fiber attachment process to achieve precise alignment to the photonic chip 104. The exposed optical fibers 108 may be coupled to the fiber alignment structure 106 to allow light coupling between the optical fiber ribbon 102 and the photonic chip 104. The optical fiber ribbon 102 may have a length extending away from the photonic chip 104 generally along the x-axis and a corresponding width generally along the y-axis perpendicular to the length.

The optical assembly 100 may further include a fixture 112 coupled to the optical fiber ribbon 102. The fixture 112 may be permanently coupled to the optical fiber ribbon 102 prior to performing the fiber attachment process to the photonic chip 104, as illustrated in FIG. 1A. The fixture 112 may be made of a substantially rigid material, for example, glass or quartz. The fixture 112 may be positioned over the optical fiber ribbon 102 such that a first end 112_{E1} may be over the exposed optical fibers 108, while an opposite second end 112_{E2} may extend over the optical fiber ribbon 102. The fixture 112 may be adapted to transmit an external downward mechanical force onto the exposed optical fibers 108, facilitating passive alignment of the exposed optical fibers 108 to the photonic chip 104 when the mechanical force is applied near the first end 112_{E1} of the fixture 112.

The fixture 112 may include a plank section 114, a first beam section 116, and a second beam section 118. The plank section 114 may be substantially planar and have a substantially uniform thickness with flat upper and lower surfaces, as illustrated in FIG. 1C. The fixture 112 may be a non-monolithic structure. As used herein, the term “non-monolithic” refers to structures that include components that can be formed separately and then bonded together to form an integrated structure. For example, the plank section 114, the first beam section 116, and the second beam section 118 are discrete components formed separately and subsequently joined together by an adhesive, such as epoxy resin, to form the fixture 112.

The plank section 114 may be substantially parallel to the section of optical fiber ribbon 102 thereunder. The plank section 114 may exhibit a slight degree of mechanical flexibility, i.e., the plank section 114 may flex up or down to a slight degree without permanent deformation. The plank section 114 may have a length extending in the same direction as the optical fiber ribbon 102, generally along the x-axis, and a width extending perpendicular to the length, generally along the y-axis. In an embodiment of the disclosure, the width of the plank section 114 may be at least as wide as the width of the optical fiber ribbon 102, with FIGS. 1A and 1B illustrating the plank section 114 being wider than the optical fiber ribbon 102.

The first beam section 116 and the second beam section 118 may be arranged under the plank section 114 extending linearly along the width of the plank section 114, generally along the y-axis. The boundaries of the first beam section 116 and the second beam section 118 under the plank section 114 are illustrated with dashed lines in FIGS. 1A and 1B for purposes of illustration. The first beam section 116 and the second beam section 118 may or may not extend the full width of the plank section 114, as long as the first beam section 116 and the second beam section 118 have a length at least as long as the width of the optical fiber ribbon 102.

The first beam section 116 may be arranged proximately to the first end 112_{E1} of the fixture 112 such that the exposed optical fibers 108 may be vertically aligned between the first beam section 116 and the fiber alignment structure 106 of the photonic chip 104 after the fiber attachment process. FIG. 1C illustrates the first beam section 116 at the first end 112_{E1} sharing two edges of the plank section 114, i.e., a first edge along the length of the plank section 114, generally along the x-axis, and a second edge along the width of the plank section 114, generally along the y-axis; the first edge and the second edge sharing a point of intersection. In other embodiments of the disclosure, the first beam section 116 may be arranged with an inward offset from the first end 112_{E1} of the fixture 112 and vertically aligned over the exposed optical fibers 108. For example, as shown in FIG. 3, a first beam section 316 is arranged with an inward offset from a first end 312_{E1} of a fixture 312.

The first beam section 116 may be spaced apart from the exposed optical fibers 108 by a separation distance, as further illustrated in FIG. 1C, and does not establish contact with the exposed optical fibers 108 when the plank section 114 is in a neutral state, i.e., when no external mechanical force is applied near the first end 112_{E1} of the fixture 112 and the plank section 114 retains the original shape. The first beam section 116 may include a flat lower surface that engages with the exposed optical fibers 108 upon the application of the external mechanical force near the first end 112_{E1} of the fixture 112 to temporarily deform the plank section 114 to a slight degree in a downward direction towards the exposed optical fibers 108. The flat lower surface of the first beam section 116 may ensure that a blunt mechanical force is being applied to the exposed optical fibers 108, thereby protecting the structural integrity thereof.

The second beam section 118 may be spaced apart from the first beam section 116 such that the second beam section 118 may be nearer to the second end 112_{E2} of the fixture 112 than the first end 112_{E1}. The second beam section 118 may be arranged over the sheathed portion of the optical fiber ribbon 102, with an inward offset from the second end 112_{E2} of the fixture 112 so as to be farther from the second end 112_{E2} than the first beam section 116 is from the first end 112_{E1} of the fixture 112. The second beam section 118 may support the fixture 112 over the optical fiber ribbon 102. The second beam section 118 may be thicker than the first beam section 116, so as to maintain the separation distance between the first beam section 116 and the exposed optical fibers 108. Accordingly, the second beam section 118 may include a lower surface at a lower level than the lower surface of the first beam section 116. The second beam section 118 may be permanently coupled to the optical fiber ribbon 102 by an adhesive, such as epoxy resin, to the plank section 114. For example, a first side of the second beam section 118 may be bonded to an underside of the plank section 114 and a second side opposite to the first side of the second beam section 118 may be bonded to the optical fiber ribbon 102.

As illustrated in FIG. 1C, the fixture 112 may be coupled to an upper surface of the optical fiber ribbon 102 solely by the second beam section 118, without the plank section 114 coming into direct contact with the optical fiber ribbon 102. In another embodiment of the disclosure, the second beam section 118 may be vertically aligned over the exposed optical fibers 108, as long as the first end 112_{E1} of the fixture 112 may retain the slight mechanical flexibility necessary to engage with the exposed optical fibers 108 without permanent deformation when the downward mechanical force is applied. In yet another embodiment of the disclosure, the fixture 112 may include one or more further beams coupled to the optical fiber ribbon 102 as long as the first end 112_{E1} of the fixture 112 may retain the slight mechanical flexibility necessary to engage with the exposed optical fibers 108 without permanent deformation when the downward mechanical force is applied.

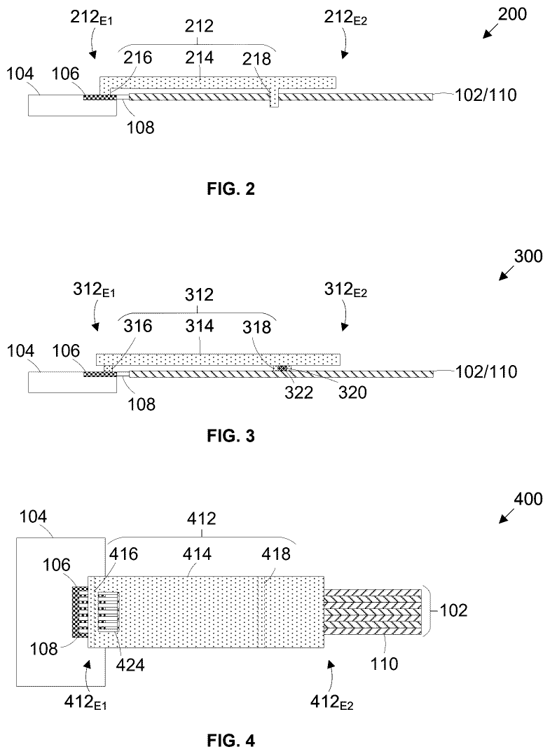

FIG. 2 is a cross-sectional view of an optical assembly 200 after a fiber attachment process, according to another embodiment of the disclosure. The optical assembly 200 may be similar to the optical assembly 100, and thus common features are labeled with the same reference numerals and need not be separately discussed.

The optical assembly 200 may include a fixture 212 coupled to the optical fiber ribbon 102. The fixture 212 may be a monolithic structure. As used herein, the term “monolithic” refers to a structure made up of a single, unified, and indivisible entity. The fixture 212 may be permanently coupled to the optical fiber ribbon 102 prior to performing the fiber attachment process to the photonic chip 104. The fixture 212 may be similar to the fixture 112 in FIG. 1C. For example, the fixture 212 may be positioned over the optical fiber ribbon 102 such that a first end 212_{E1} may be over the exposed optical fibers 108, while an opposite second end 212_{E2} may extend over the optical fiber ribbon 102. The fixture 212 may be adapted to transmit an external downward mechanical force onto the exposed optical fibers 108, facilitating passive alignment of the exposed optical fibers 108 to the photonic chip 104 when the mechanical force is applied near the first end 212_{E1} of the fixture 212.

The fixture 212 may include a plank section 214 having a first beam section 216 section and a second beam section 218 extending downward from under the plank section 214. The plank section 214, the first beam section 216, and the second beam section 218 may be similar to the plank section 114, the first beam section 116, and the second beam section 118 of the fixture 112 in FIG. 1C. For example, the first beam section 216 of the fixture 212 may be vertically aligned over the exposed optical fibers 108 of the optical fiber ribbon 102, and the second beam section 218 may be arranged with an inward offset from the second end 212_{E2} of the fixture 212. In another example, the first beam section 216 section and the second beam section 218 section may or may not extend the full width of the plank section 214, as long as the first beam section 216 and the second beam section 218 have a length at least as long as the width of the optical fiber ribbon 102.

The first beam section 216 may be arranged near the first end 212_{E1} of the fixture 212 such that the first beam section 216 may be vertically aligned over the fiber alignment structure 106 after the fiber attachment process. In an embodiment of the disclosure, the first beam section 216 may be in contact with the fiber alignment structure 106 of the photonic chip 104 after the fiber attachment process. In another embodiment of the disclosure, although not shown in the accompanying drawings, the first beam section 216 may be indirectly in contact with the fiber alignment structure 106 of the photonic chip 104 through the exposed optical fibers 108 after the fiber attachment process. The first beam section 216 section may extend inwardly from an edge of the first end 212_{E1}, as illustrated, or may be arranged with an inward offset from the first end 212_{E1} of the fixture 212 (see FIG. 3). Although not shown in FIG. 2, the first beam section 216 section may be spaced apart from the exposed optical fibers 108 by a separation distance and does not establish contact with the exposed optical fibers 108 when the plank section 214 is in a neutral state, similarly to the first beam section 116 in FIG. 1C. The first beam section 216 may include a flat lower surface that engages with the exposed optical fibers 108 upon the application of an external mechanical force near the first end 212_{E1} of the fixture 212 to temporarily deform the plank section 214 to a slight degree in a downward direction towards the exposed optical fibers 108. The flat lower surface of the first beam section 216 may ensure that a blunt mechanical force is being applied to the exposed optical fibers 108, thereby protecting the structural integrity thereof.

The second beam section 218 may be spaced apart from the first beam section 216 such that the second beam section 218 may be nearer to the second end 212_{E2} of the fixture 212 than the first end 212_{E1}. The second beam section 218 may extend to a level lower than the first beam section 216 section from the plank section 214, and may further extend downward to a level under the optical fiber ribbon 102. In an embodiment of the disclosure, the second beam section 218 section may include a prong (not shown) extending under and supporting the optical fiber ribbon 102, preferably with an adhesive, such as epoxy resin, to stabilize the fixture 212 onto the optical fiber ribbon 102. As illustrated, the fixture 112 may be coupled to the optical fiber ribbon 102 by the second beam section 218, without the plank section 214 coming into direct contact with the optical fiber ribbon 102. This configuration may enable the fixture 212 to return to the neutral state after the downward mechanical force is removed after the fiber attachment process. In another embodiment of the disclosure, the fixture 212 may include one or more further beam sections coupled to the optical fiber ribbon 102 as long as the first end 212_{E1} of the fixture 212 may retain the slight mechanical flexibility to engage with the exposed optical fibers 108 without permanent deformation when the downward mechanical force is applied.

During the fiber attachment process, the optical fiber ribbon 102 may be coupled to the photonic chip 104 by placing the exposed optical fibers 108 over the fiber alignment structure 106 of the photonic chip 104, and an external downward mechanical force may be applied to the fixture 212 near the first end 212_{E1} thereof. The mechanical force may be applied via a push pin, transmitted through the plank section 214 to the first beam section 216, and further onto the exposed optical fibers 108 in a downward direction for the alignment onto the V-grooves of the fiber alignment structure 106. The first end 212_{E1} of the plank section 214 and the first beam section 216 may be held in place by an adhesive, such as epoxy resin, after the mechanical force is removed. The adhesive is not shown in the accompanying drawings for clarity purposes.

As mentioned, at least the first beam section 216 may have a length at least as long as the width of the optical fiber ribbon 102, such that the applied mechanical force may be uniformly exerted onto all the exposed optical fibers 108 of the optical fiber ribbon 102 during the fiber attachment process. As the exposed optical fibers 108 exhibit a slight degree of mechanical flexibility, the exposed optical fibers 108 may be temporarily deformed and passively self-align with the V-grooves of the fiber alignment structure 106 when the external downward mechanical force is transmitted through the first beam section 216 of the fixture 212. This fiber attachment process facilitates precise alignment and proper positioning of the optical fiber ribbon 102 to the photonic chip 104, resulting in a high-speed and repeatable fiber alignment process to the photonic chip 104. The fiber attachment process may continue with an application of adhesive onto the exposed optical fibers 108 and also over the fixture 212, at least over the first end 112_{E1} thereof, to ensure stable attachment of the optical fiber ribbon 102 to the photonic chip 104.

FIG. 3 is a cross-sectional view of an optical assembly 300 after a fiber attachment process, according to another embodiment of the disclosure. The optical assembly 300 may be similar to the optical assembly 100, and thus common features are labeled with the same reference numerals and need not be separately discussed.

The optical assembly 300 may include a fixture 312 coupled to the optical fiber ribbon 102. The fixture 312 may be permanently coupled to the optical fiber ribbon 102 prior to performing the fiber attachment process to the photonic chip 104. The fixture 112 may be a non-monolithic structure, as illustrated, or a monolithic structure similar to the fixture 212 in FIG. 2. The fixture 312 may be permanently coupled to the optical fiber ribbon 102 prior to performing the fiber attachment process to the photonic chip 104. The fixture 312 may be similar to the fixture 112 in FIG. 1C. For example, the fixture 312 may be positioned over the optical fiber ribbon 102 such that a first end 312_{E1} may be over the exposed optical fibers 108, while an opposite second end 312_{E2} may extend over the optical fiber ribbon 102. The fixture 312 may be adapted to transmit an external downward mechanical force onto the exposed optical fibers 108, facilitating passive alignment of the exposed optical fibers 108 to the photonic chip 104 when the force is applied near the first end 312_{E1} of the fixture 312.

The fixture 312 may include a plank section 314 having a first beam section 316 and a second beam section 318 extending downward from under the plank section 314. The first beam section 316 may be similar to the first beam section 116 in FIG. 1C. For example, the first beam section 316 of the fixture 312 may be vertically aligned over the exposed optical fibers 108 of the optical fiber ribbon 102, and the second beam section 318 may be arranged with an inward offset from the second end 312_{E2} of the fixture 312. In another example, the first beam section 316 and the second beam section 318 may or may not extend the full width of the plank section 314, as long as the first beam section 316 and the second beam section 318 have a length at least as long as the width of the optical fiber ribbon 102.

The second beam section 318 may be spaced apart from the first beam section 316 such that the second beam section 318 may be nearer to the second end 312_{E2} of the fixture 312 than the first end 312_{E1}. The second beam section 318 may support the fixture 312 over the optical fiber ribbon 102, and may include an opening 320 within which an adhesive 322, such as epoxy resin, may be used to fill the opening 320. As illustrated, the fixture 312 may be coupled to the optical fiber ribbon 102 by the second beam section 318, without the plank section 314 coming into direct contact with the optical fiber ribbon 102. In this embodiment, the amount of adhesive 322 applied for the coupling the fixture 312 to the optical fiber ribbon 102 may exceed that used for optical assemblies 100, 200. As a result, the fixture 312 may be more securely coupled to the optical fiber ribbon 102, increasing the overall structural stability of the optical assembly 300. In an embodiment of the disclosure, the fixture 312 may include one or more further beam sections coupled to the optical fiber ribbon 102 as long as the first end 312_{E1} of the fixture 312 may retain the slight mechanical flexibility to engage with the exposed optical fibers 108 without permanent deformation when the downward mechanical force is applied.

FIG. 4 is a top-down view of an optical assembly 400, according to another embodiment of the disclosure. The optical assembly 400 may be similar to the optical assembly 100, and thus common features are labeled with the same reference numerals and need not be separately discussed.

The optical assembly 400 may include a fixture 412 coupled to the optical fiber ribbon 102. The fixture 412 may be a non-monolithic structure, similar to the fixture 112 in FIG. 1B, or a monolithic structure similar to the fixture 212 in FIG. 2. The fixture 412 may be permanently coupled to the optical fiber ribbon 102 prior to performing the fiber attachment process to the photonic chip 104. The fixture 412 may be similar to the fixture 112 in FIG. 1C. For example, the fixture 412 may be positioned over the optical fiber ribbon 102 such that a first end 412_{E1} may be over the exposed optical fibers 108, while an opposite second end 412_{E2} may extend over the optical fiber ribbon 102. The fixture 412 may be adapted to transmit an external downward mechanical force onto the exposed optical fibers 108, facilitating passive alignment of the exposed optical fibers 108 to the photonic chip 104 when the force is applied near the first end 412_{E1} of the fixture 412.

The fixture 412 may include a plank section 414 having a first beam section 416 section and a second beam section 418 extending downward from under the plank section 414. The first beam section 416 section may be similar to the first beam section 116 section in FIG. 1C. For example, the first beam section 416 of the fixture 412 may be vertically over the exposed optical fibers 108 of the optical fiber ribbon 102, and the second beam section 418 may be arranged with an inward offset from the second end 412_{E2} of the fixture 412. In another example, the first beam section 416 and the second beam section 418 may or may not extend the full width of the plank section 414, as long as the first beam section 416 and the second beam section 418 have a length at least as long as the width of the optical fiber ribbon 102.

The plank section 414 of the fixture 412 may include an opening 424 adjacent to the first beam section 416. The opening 424 may be vertically aligned over at least a portion of the exposed optical fibers 108 of the optical fiber ribbon 102 and a portion of the fiber alignment structure 106 of the photonic chip 104. An adhesive, such as epoxy resin, may be applied through the opening 424 after coupling the exposed optical fibers 108 on the fiber alignment structure 106 of the photonic chip. In this embodiment, the amount of adhesive applied for coupling the fixture 412 to the optical fiber ribbon 102 may exceed that used for optical assemblies 100, 200, 300. As a result, the fixture 412 may be more securely coupled to the optical fiber ribbon 102, as well as to the photonic chip 104, increasing the overall structural stability of the optical assembly 400.

The terms “top”, “bottom”, “over”, “under”, and the like in the description and the claims, if any, are used for descriptive purposes and not necessarily for describing permanent relative positions. It is to be understood that the terms so used are interchangeable under appropriate circumstances such that the embodiments of the devices described herein are, for example, capable of operation in other orientations than those illustrated or otherwise described herein.

Additionally, the formation of a first feature over or on a second feature in the description that follows may include embodiments in which the first and second features are formed in direct contact and may also include embodiments in which additional features may be formed by interposing the first and second features, such that the first and second features may not be in direct contact.

Similarly, if a method is described herein as involving a series of steps, the order of such steps as presented herein is not necessarily the only order in which such steps may be performed, and certain of the stated steps may possibly be omitted and/or certain other steps not described herein may possibly be added to the method. Furthermore, the terms “comprise”, “include”, “have”, and any variations thereof, are intended to cover a non-exclusive inclusion, such that a process, method, article, or device that comprises a list of features is not necessarily limited to those features but may include other features not expressly listed or inherent to such process, method, article, or device. Occurrences of the phrase “in an embodiment” herein do not necessarily all refer to the same embodiment. In addition, unless otherwise indicated, all numbers expressing quantities, ratios, and numerical properties of materials, reaction conditions, and so forth used in the specification and claims are to be understood as being modified in all instances by the term “about”.

Furthermore, approximating language, as used herein throughout the specification and claims, may be applied to modify any quantitative representation that could permissibly vary without resulting in a change in the basic function to which it is related. Accordingly, a value modified by a term or terms, such as “approximately”, “about,” or “substantially” is not limited to the precise value specified. In some instances, the approximating language may correspond to the precision of an instrument for measuring the value. In other instances, the approximating language may correspond to within normal tolerances of the semiconductor industry. For example, “substantially coplanar” means substantially in a same plane within normal tolerances of the semiconductor industry, and “substantially perpendicular” means at an angle of 90 degrees plus or minus a normal tolerance of the semiconductor industry.

While several exemplary embodiments have been presented in the above-detailed description of the device, it should be appreciated that a number of variations exist. It should further be appreciated that the embodiments are only examples, and are not intended to limit the scope, applicability, dimensions, or configuration of the device in any way. Rather, the above-detailed description will provide those skilled in the art with a convenient road map for implementing an exemplary embodiment of the device, it is understood that various changes may be made in the function and arrangement of features and methods of fabrication described in an exemplary embodiment without departing from the scope of this disclosure as set forth in the appended claims.

What is claimed is:

1. An optical assembly, comprising:
a photonic chip;
an optical fiber ribbon comprising a plurality of optical fibers each sheathed with an outer protective coating, wherein a portion of the optical fibers is exposed at an end portion of the optical fiber ribbon and coupled to the photonic chip; and
a fixture over the optical fiber ribbon, wherein the fixture comprises a first end over the exposed optical fibers and a second end over the sheathed portion of the optical fiber ribbon.

2. The optical assembly of claim 1, wherein the fixture comprises:
a plank section over the optical fiber ribbon;
a first beam section under the plank section near the first end of the fixture, wherein the first beam section is vertically aligned over the exposed optical fibers; and
a second beam section under the plank section spaced apart from the first beam section, wherein the second beam section is nearer to the second end of the fixture than the first end.

3. The optical assembly of claim 2, wherein the first beam section comprises a flat lower surface.

4. The optical assembly of claim 2, wherein the second beam section is farther from the second end of the fixture than the first beam section is to the first end.

5. The optical assembly of claim 4, wherein the first beam section and the second beam section are arranged linearly along a width of the optical fiber ribbon.

6. The optical assembly of claim 5, wherein each of the first beam section and the second beam section has a length at least as long as the width of the optical fiber ribbon.

7. The optical assembly of claim 5, wherein the fixture is coupled to the optical fiber ribbon at the second beam section by an adhesive.

8. The optical assembly of claim 7, wherein the second beam section is coupled to an upper surface of the optical fiber ribbon.

9. The optical assembly of claim 8, wherein the second beam section comprises an opening and the opening is filled with an adhesive.

10. The optical assembly of claim 7, wherein the second beam section extends to a level under the optical fiber ribbon.

11. The optical assembly of claim 7, wherein the plank section comprises an opening adjacent to the first beam section.

12. The optical assembly of claim 11, wherein the opening is over at least a portion of the exposed optical fibers and a portion of the photonic chip.

13. The optical assembly of claim 2, wherein the fixture is a non-monolithic structure.

14. The optical assembly of claim 2, wherein the fixture is a monolithic structure.

15. A method of forming an optical assembly, comprising:
coupling a fixture over an optical fiber ribbon having an end portion with a portion of exposed optical fibers, wherein the fixture comprises a first end over the exposed optical fibers and a second end over the optical fiber ribbon; and
coupling the optical fiber ribbon with the fixture to a photonic chip, wherein the exposed optical fibers are vertically aligned between the photonic chip and the fixture.

16. The method of claim 15, wherein coupling the fixture over the optical fiber ribbon comprises:
applying an adhesive to a beam section of the fixture; and
coupling the beam section to the optical fiber ribbon, wherein the beam section is a first beam section and the fixture further comprising:
a plank section;
a second beam section under the plank section, wherein the second beam section is vertically aligned over the exposed optical fibers; and
the first beam section is under the plank section spaced apart from the second beam section, wherein the first beam section is over the optical fiber ribbon and extends to a level lower than the first beam section.

17. The method of claim 16, wherein the first beam section comprises an opening, further comprising filling the opening of the first beam section with the adhesive to couple the fixture to the optical fiber ribbon.

18. The method of claim 16, further comprising:
forming an opening in the plank section of the fixture over at least a portion of the exposed optical fibers and a portion of the photonic chip; and
applying an adhesive through the opening to couple the optical fiber ribbon to the fixture and the photonic chip.

19. The method of claim 16, wherein the fixture is formed monolithically.

20. The method of claim 16, wherein the fixture is formed non-monolithically.
